(19) United States
(12) Patent Application Publication
(10) Pub. No.: US 2009/0124781 A1
(43) Pub. Date: May 14, 2009

(54) Method of Making Branched Polysilane Copolymers

(76) Inventors: Travis Hein, Bay City, MI (US); Russell King, Midland, MI (US); Binh Thanh Nguyen, Midland, MI (US); Herschel Henry Reese, Midland, MI (US); Michael Andrew Smith, Midland, MI (US); Hanh Xuan Vo, Midland, MI (US)

Correspondence Address: DOW CORNING CORPORATION CO1232, 2200 W. SALZBURG ROAD, P.O. BOX 994, MIDLAND, MI, 48686-0994, US

(21) Appl. No.: 11/884,611

(22) PCT Filed: Mar. 29, 2006
(86) PCT No.: PCT/US06/11525

§ 371 Date: Aug. 16, 2007

Related U.S. Application Data
(60) Provisional application No. 60/675,635, filed on Apr. 28, 2005.

(51) Int. Cl. C08G 77/00

(52) U.S. Cl. 528/10

(57) ABSTRACT

Branched polysilane copolymers are prepared via a Wurtz-type coupling reaction by reacting a mixture of two different dihalosilanes and a single trihalosilane with an alkali metal coupling agent in an organic liquid medium. The branched polysilane copolymers are recovered from the reaction mixture. Capped branched polysilane copolymers are prepared via the same Wurtz-type coupling reaction with addition of a capping agent to the reaction mixture. The capping agent is a monohalosilane, monoalkoxysilane, dialkoxysilane, or trialkoxysilane. The branched polysilane copolymers and the capped branched polysilane copolymers are soluble in organic liquid medium.

### CROSS REFERENCE TO RELATED APPLICATIONS

This application claims priority to U.S. Provisional Application No. 60/675,635, filed Apr. 28, 2005.

### FIELD OF THE INVENTION

This invention is related to a method of making branched polysilane copolymers, in particular to a Wurtz-type coupling reaction of two different dihalosilanes and a single trihalosilane. The improvement according to the method of the invention is that it produces branched polysilane copolymers rather than branched polysilane homopolymers. The branched polysilane copolymers are soluble in organic liquid mediums.

### BACKGROUND OF THE INVENTION

The earliest synthetic procedure for the preparation of polysilanes utilized the Wurtz-type reductive coupling of dichlorosilanes. Polysilanes can be prepared by other synthetic routes. For example, polysilanes have been prepared by (i) the dehydrocoupling of monosubstituted silanes using a transition metal catalyst, (ii) the ring opening polymerization of cyclosiloxanes, (iii) anionic polymerization of masked silanes, and (iv) the sonochemical coupling of dichlorosilanes with an alkali metal.

However, in spite of efforts to displace it, the Wurtz reductive-coupling of dichlorosilanes to make polysilanes remains the most common and generally accepted procedure for the synthesis of polysilanes. Although the synthesis of polysilanes by the reductive coupling of dichlorosilanes with an alkali metal such as sodium in a solvent such as toluene at 100° C. possesses poor reproducibility and low yields, Wurtz-type coupling still remains the overall the most effective procedure for making polysilanes. Yet, it still remains very difficult and challenging to reproduce preparation methods for polysilanes, since the development of chemical processes for manufacturing polysilanes is complicated and fraught with difficulty.

A method of preparing a branched polysilane by reacting one dihalosilane and one trihalosilane is described in U.S. Provisional Patent Application Ser. No. 60/571,184, filed on May 14, 2004, and assigned to the same assignee as the present application. However, the method according to the '184 application uses one dihalosilane and one trihalosilane, and therefore it produces branched polysilanes that are homopolymers, rather than branched polysilane copolymers according to this invention.

U.S. Pat. No. 2,563,005 (Aug. 7, 1951), also assigned to the same assignee as the present invention, describes a method for preparing certain organopolysilanes in Example 12, by reacting two dihalosilanes and two trihalosilanes. However, the method according to the '005 patent produces polysilane resins that are highly crosslinked molecules, rather than branched polysilane copolymers according to this invention.

### SUMMARY OF THE INVENTION

The invention is directed to a first method of preparing branched polysilane copolymers by a Wurtz-type coupling reaction, by reacting a mixture of two different dihalosilanes and a single trihalosilane, with an alkali metal coupling agent in an organic liquid medium. Branched polysilane copolymers are recovered from the reaction mixture.

The invention is also directed to a second method of preparing branched polysilane copolymers by a Wurtz-type coupling reaction, by reacting a mixture of two different dihalosilanes and a single trihalosilane, with an alkali metal coupling agent in an organic liquid medium. A capping agent is added to the reaction mixture, and capped branched polysilane copolymers are recovered from the reaction mixture. The capping agent can be a monohalosilane, monoalkoxysilane, dialkoxysilane, or trialkoxysilane.

In these embodiments, it is preferred that the organic liquid medium is one in which the branched polysilane copolymer is soluble. Most preferably the organic liquid is toluene. Typically, the alkali metal coupling agent selected is sodium. The reaction can be carried out at a temperature in the range of 50-200° C. Preferably, the temperature is in the range of 110-115° C., which is close to the melting temperature of sodium, offering some advantage in manufacturing in terms of dispersion of the sodium.

The method involves reacting a mixture of a first dihalosilane, a second dihalosilane, and a single trihalosilane, having respectively the formulas:

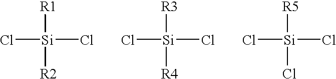

R1, R2, R3, R4, and R5 represent an alkyl group, a cycloalkyl group, an aryl group, an aralkyl group, an alkaryl group, or an alkenyl group; provided however that the R1 group and the R2 group in the first dihalosilane are not the same as the R3 group and the R4 group in the second dihalosilane. These and other features of the invention will become apparent from a consideration of the detailed description.

### DETAILED DESCRIPTION OF THE INVENTION

The most common method used for the synthesis of polysilanes is the Wurtz-type coupling of two dihalosilanes as shown below.

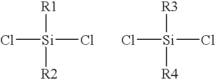

This sodium coupling reaction is typically carried out in a refluxing hydrocarbon such as toluene. It produces a mixture of linear polysilanes, oligomeric polysilanes, and cyclic polysilanes, with the yield of linear polysilanes being in low to moderate ranges.

In contrast to the above, the method according to the present invention involves a Wurtz-type coupling of two different dihalosilanes such as shown above, and a single trihalosilane, rather than Wurtz-type coupling of two dihalosilanes. The method of the invention is therefore capable of producing branched polysilane copolymers, rather than branched polysilane homopolymers. The trihalosilane used in the method according to the invention is shown below.

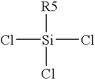

Illustrative of R1, R2, R3, R4, and R5 groups include alkyl groups such as the methyl, ethyl, propyl, isopropyl, butyl, amyl, hexyl, octyl, decyl, dodecyl, octadecyl, and myricyl groups; cycloalkyl groups such as the cyclobutyl and cyclohexyl groups; aryl groups such as the phenyl, xenyl, and naphthyl groups; aralkyl groups such as the benzyl and 2-phenylethyl groups; alkaryl groups such as the tolyl, xylyl and mesityl groups, and alkenyl groups such as vinyl, allyl, and 5-hexenyl. However, it is provided that the R1 group and the R2 group in one dihalosilane cannot be the same as the R3 group and the R4 group in the other dihalosilane.

As noted previously, the capping agents according to the method of the invention can be a monohalosilane, monoalkoxysilane, dialkoxysilane, or a trialkoxysilane.

Some examples of monohalosilanes that can be used include benzyldimethylchlorosilane, n-butyldimethylchlorosilane, tri-n-butylchlorosilane, ethyldimethylchlorosilane, triethylchlorosilane, trimethylchlorosilane, n-octadecyldimethylchlorosilane, phenyldimethylchlorosilane, triphenylchlorosilane, cyclohexyldimethylchlorosilane, cyclopentyldimethylchlorosilane, n-propyldimethylchlorosilane, tolyldimethylchlorosilane, allyldimethylchlorosilane, 5-hexenyldimethylchlorosilane, and vinyldimethylchlorosilane.

Some examples of dihalosilanes that can be used include t-butylphenyldichlorosilane, dicyclohexyldichlorosilane, diethyldichlorosilane, dimethyldichlorosilane, diphenyldichlorosilane, hexylmethyldichlorosilane, phenylethyldichlorosilane, phenylmethyldichlorosilane, (3-phenylpropyl)methyldichlorosilane, diisopropyldichlorosilane, (4-phenylbutyl)methyldichlorosilane, n-propylmethyldichlorosilane, allylmethyldichlorosilane, and vinylmethyldichlorosilane.

Some examples of trihalosilanes that can be used include benzyltrichlorosilane, n-butyltrichlorosilane, cyclohexyltrichlorosilane, n-decyltrichlorosilane, dodecyltrichlorosilane, ethyltrichlorosilane, n-heptyltrichlorosilane, methyltrichlorosilane, n-octyltrichlorosilane, pentyltrichlorosilane, phenyltrichlorosilane, allyltrichlorosilane, 5-hexenyltrichlorosilane, and vinyltrichlorosilane.

Some examples of monoalkoxysilanes that can be used include t-butyldiphenylmethoxysilane, trimethylethoxysilane, trimethylmethoxysilane, trimethyl-n-propoxysilane, n-octadecyldimethylmethoxysilane, octyldimethylmethoxysilane, cyclopentyldiethylmethoxysilane, dicyclopentylmethylmethoxysilane, tricyclopentylmethoxysilane, phenyldimethylethoxysilane, diphenylmethylethoxysilane, triphenylethoxysilane, and vinyldimethylethoxysilane.

Some examples of dialkoxysilanes that can be used include dibutyldimethoxysilane, dodecylmethyldiethoxysilane, diethyldiethoxysilane, dimethyldimethoxysilane, dimethyldiethoxysilane, n-octylmethyldiethoxysilane, octadecylmethyldimethoxysilane, diphenyldiethoxysilane, diphenyldimethoxysilane, phenylmethyldiethoxysilane, phenylmethyldimethoxysilane, diphenyldimethoxysilane, and vinylmethyldimethoxysilane.

Some examples of trialkoxysilanes that can be used include benzyltriethoxysilane, cyclohexyltrimethoxysilane, n-decyltriethoxysilane, dodecyltriethoxysilane, ethyltriethoxysilane, hexadecyltriethoxysilane, methyltriethoxysilane, octyltriethoxysilane, phenyltriethoxysilane, phenyltrimethoxysilane, n-propyltrimethoxysilane, allyltrimethoxysilane, and vinyltrimethoxysilane.

The silanes used in the reaction are present in the stoichiometric proportion necessary to carry out the reaction and bring the reaction to completion.

The alkali metal coupling agent used in the process of the invention can be sodium, potassium, or lithium. Sodium is preferred however, as it provides the highest yield of branched polysilane copolymers. The amount of alkali metal used in the reaction is at least three moles per mole of the silanes utilized. In order to ensure completion of the reaction, it is preferred to add an amount slightly in excess of three moles of the alkali metal per mole of silanes.

The process of the invention can be facilitated by addition of an alcohol having 1-8 carbon atoms. The function of the alcohol is to oxidize the sodium metal to a sodium salt, that can then be centrifuged, and easily removed. Representative alcohols that can be used include methanol, ethanol, propanol, isopropanol, butanol, isobutanol, sec-butanol, tert-butanol, pentanol, hexanol, heptanol and octanol. Combinations of alcohols can also be employed.

The organic liquid medium in which the reaction takes place may be any solvent in which the dihalosilane and trihalosilane reactants are soluble. Preferably, the solvent used is one in which the branched polysilane copolymer which is produced in the process is also soluble. These solvents include hydrocarbon solvents such as toluene; paraffins; ethers; and nitrogen containing solvents such as triethylamine, N,N,N′,N′-tetramethylethylene diamine, and cyclohexylamine. The organic liquid medium can be a mixture of solvents such as a hydrocarbon solvent and an ether, one example of which is toluene and anisole. Preferably, toluene is used as the organic liquid medium. The organic liquid medium is not generally a solvent for the alkali metal halides that are formed, and these can be easily removed by filtration. The amount of organic liquid medium used in the process is not critical, although the use of progressively larger amounts can result in branched polysilane copolymers of progressively lower molecular weight.

The process may be carried out at any temperature, but preferably the reaction temperature is in the range of 50-200° C., preferably 110-115° C. The reaction that occurs is exothermic, and is preferably initiated at room temperature. No external heat is supplied during the reaction. If the temperature is increased, an increase in the molecular weight of the formed branched polysilane copolymers is usually observed. This may lead to the production of branched polysilane copolymers that are insoluble in the organic liquid medium however.

The reproducibility of the process is determined by the reproducibility of local mass and heat transfer operations. Since the intrinsic reaction kinetics are very fast, the overall process has to be controlled by mass and heat transfer. In this regard, mass/heat transfer can be controlled by (i) maintaining the power/volume above the level necessary for suspending the sodium droplets or particles, (ii) adding the reactants sub-surface wise into well-mixed zones, and (ii) precisely controlling the rate of addition. For instance, the rate of addition of the chlorosilanes is an important factor in controlling the molecular weight distribution.

When the reaction has proceeded to the desired degree, the branched polysilane copolymer may be recovered from the reaction mixture by any suitable method. If the branched polysilane copolymer is insoluble in the liquid organic material in which the reaction took place, it can be filtered out from the mixture. This is preferably done when other insolubles, such as the alkali metal halides that are formed as a side product, have been removed by scooping or decanting. Depending on the components of the reaction, the solid byproduct may float towards the surface of the mixture, while the branched polysilane copolymers tend to precipitate. If the branched polysilane copolymer is soluble in the solvent, other insolubles can be removed by filtration. The branched polysilane copolymer can be retained in the solvent, purified by washing, or dried to a powder.

### EXAMPLES

The following examples are set forth in order to illustrate the invention in more detail.

### Example 1

### Synthesis of Branched Polysilane Co-Polymer

### Preparation of a Phenyl-Methyl, Diphenyl, Methyl Terpolymer

Toluene (4,025 gram) and sodium metal (163 gram) were loaded into a cylindrical, glass, six liter reaction vessel, and then the toluene was brought to reflux with a recirculation bath through the jacket. A nitrogen atmosphere with a slight positive pressure was maintained throughout the procedure. A dual pitched-blade impeller was then used to disperse the molten sodium, and the jacket temperature was maintained at 110° C. A mixture containing phenyl methyl dichlorosilane (365 gram), diphenyl dichlorosilane (127 gram), and methyl trichlorosilane (89.3 gram), was then introduced to the reaction vessel over sixty minutes via a dip tube positioned just above the upper impeller, resulting in an exotherm to 113° C. After holding the reaction temperature for 16 hours, the contents were cooled to 40° C. before methanol (455 gram) was added slowly to oxidize the residual sodium. This slurry was then centrifuged to separate the salt. The toluene solution (2,690 gram) was filtered, and then concentrated to 1,028 gram by vacuum evaporation. The solution was added slowly to methanol (9,800 gram) to precipitate the product, which was then filtered and dried in a vacuum oven. The yield was 200.1 gram of a powdery white solid. This material was re-dissolved in toluene (371 gram), filtered, precipitated once more into methanol (2400 gram), filtered, and vacuum dried to 175.2 gram of the product. Gel permeation chromatography indicated a molecular weight of 6,190 with a polydispersity of 3.8. The maximum absorption in the UV range, i.e., lambda (λ) max, was measured at 330 nanometer (nm). A 50 percent by weight solution of the product in anisole had a 99 percent transmittance T at a wavelength of 780 nanometer (nm), initially, and after several weeks in solution.

### Example 2

### Synthesis of Branched Polysilane Co-Polymer

### Preparation of a Phenyl-Methyl, Diphenyl, Methyl Terpolymer

Toluene (4,025 gram) and sodium metal (163 gram) were loaded into a cylindrical, glass, six liter reaction vessel, and then the toluene was brought to reflux with a recirculation bath through the jacket. A nitrogen atmosphere with a slight positive pressure was maintained throughout the procedure. A dual pitched-blade impeller was then used to disperse the molten sodium, and the jacket temperature was maintained at 110° C. A mixture containing phenyl methyl dichlorosilane (445 gram), diphenyl dichlorosilane (68.7 gram), and methyl trichlorosilane (69.3 gram), was then introduced to the reaction vessel over sixty minutes via a dip tube positioned just above the upper impeller, resulting in an exotherm to 113° C. After holding the reaction temperature for 2 hours, the contents were cooled to 40° C. before methanol (453 gram) was added slowly to oxidize the residual sodium. This slurry was then filtered to remove the salt. The toluene solution (4,134 gram) was concentrated to 2,109 gram by vacuum evaporation, and then filtered again. The solution was added slowly to methanol (10,500 gram) to precipitate the product, which was then filtered and dried in a vacuum oven. The yield was 224 gram of a powdery white solid. This material was re-dissolved in toluene (395 gram), filtered, precipitated once more into methanol (2,566 gram), filtered, and vacuum dried to 202 gram of the product. Gel permeation chromatography indicated a molecular weight of 46,600 with a polydispersity of 19.0. The maximum absorption in the UV range, i.e., lambda (λ) max, was measured at 332 nanometer (nm). A 50 percent by weight solution of the product in anisole had a 99 percent transmittance T at a wavelength of 780 nanometer (nm).

### Example 3

### Synthesis of Branched Polysilane Co-Polymer

### Preparation of a Phenyl-Methyl, Diphenyl, Methyl Terpolymer

Toluene (4,308 gram) and sodium metal (121 gram) were loaded into a cylindrical, glass, six liter reaction vessel, and then the toluene was brought to reflux with a recirculation bath through the jacket. A nitrogen atmosphere with a slight positive pressure was maintained throughout the procedure. A dual pitched-blade impeller was then used to disperse the molten sodium, and the jacket temperature was maintained at 110° C. A mixture containing phenyl methyl dichlorosilane (295 gram), diphenyl dichlorosilane (102 gram), and methyl trichlorosilane (50.9 gram), was then introduced to the reaction vessel over 120 minutes via a dip tube positioned just above the upper impeller, resulting in an exotherm to 112° C. After holding the reaction temperature for 2 hours, the contents were cooled to 40° C. before methanol (338 gram) was added slowly to oxidize the residual sodium. This slurry was then filtered to remove the salt. The toluene solution (4,584 gram) was concentrated to 1,028 gram by vacuum evaporation, and then filtered again. The solution was added slowly to methanol (8,500 gram) to precipitate the product, which was then filtered and dried in a vacuum oven. The yield was 172.8 gram of a powdery white solid. This material was re-dissolved in toluene (321 gram), filtered, precipitated once more into methanol (2,200 gram), filtered, and vacuum dried to 152 gram of the product. Gel permeation chromatography indicated a molecular weight of 16,500 with a polydispersity of 9.7. The maximum absorption in the UV range, i.e., lambda (λ) max, was measured at 332 nanometer (nm). A 50 percent by weight solution of the product in anisole had a 99 percent transmittance T at a wavelength of 780 nanometer (nm), initially, and after several weeks in solution.

The branched polysilane copolymers of the invention have utility in the normal applications of polysilanes, such as their use as (1) precursors for silicone carbide; (2) optoelectric materials such as photoresists; (3) organic photosensitive materials; (4) optical waveguides; (5) optical memories; (6) surface protection for glass, ceramics, and plastics; (7) anti-reflection films; (8) filter films for optical communications; (9) radiation detection; (10) wave-guides; (11) low dielectric constant (k) Chemical Vapor Deposition (CVD); (12) thin films; (13) dielectric constants; (14) laser radiation; (15) composites; (16) ink-jet printing; (17) Refractive Indexing (RI); (18) refractories; (19) nanotubes; (20) fillers; (21) membranes; (22) optical instruments; (23) semiconductor device fabrication; (24) sintering; (25) adhesives; (26) electrophoresis; (27) electric circuits; (28) electroluminescent devices; (29) solar cells; (30) photoconductors; (31) printed circuit boards; (32) photolithography; (33) nonwoven fabrics; (34) optical films; (35) porous materials; (36) optical disks; (37) electric heaters; (38) ceramics; (39) wires; (40) interconnections; (41) photo imaging materials; (42) binders; (43) thermal insulators; (44) etching masks; (45) carbonization; (46) cathodes; (47) optical fibers; (48) firing and/or heat treating; (49) heat resistant coating materials; (50) dielectric coatings; (51) cosmetics; (52) frits and/or sintered glass; and (53) crosslinking. The branched polysilane copolymers generally will have a molecular weights in the range of 1,000-50,000.

Other variations may be made in compounds, compositions, and methods described herein without departing from the essential features of the invention. The embodiments of the invention specifically illustrated herein are exemplary only and not intended as limitations on their scope except as defined in the appended claims.

We claim:

1. A method of preparing branched polysilane copolymers by a Wurtz-type coupling reaction comprising the step of reacting a mixture of a first dihalosilane, a second dihalosilane, and a single trihalosilane, with an alkali metal coupling agent in an organic liquid medium, and recovering the branched polysilane copolymers from the reaction mixture, the first dihalosilane, the second dihalosilane, and the trihalosilane, having respectively the formulas: 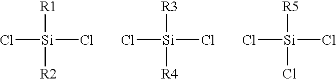
wherein R1, R2, R3, R4, and R5 represent an alkyl group, a cycloalkyl group, an aryl group, an aralkyl group, an alkaryl group, or an alkenyl group; provided that the R1 and R2 in the first dihalosilane are not the same as the R3 and R4 in the second dihalosilane.

2. The method according to claim 1 in which the alkali metal coupling agent is sodium.

3. The method according to claim 1 in which an alcohol having 1-8 carbon atoms is added to the reaction mixture to oxidize the alkali metal coupling agent.

4. A branched polysilane copolymer prepared by the method according to claim 1.

5. A method of preparing branched polysilane copolymers by a Wurtz-type coupling reaction comprising the step of reacting a mixture of a first dihalosilane, a second dihalosilane, and a single trihalosilane, with an alkali metal coupling agent in an organic liquid medium, adding a capping agent to the reaction mixture, the capping agent being selected from the group consisting of monohalosilanes, monoalkoxysilanes, dialkoxysilanes, and trialkoxysilanes, and recovering capped branched polysilane copolymers from the reaction mixture, the first dihalosilane, the second dihalosilane, and the trihalosilane, having respectively the formulas: 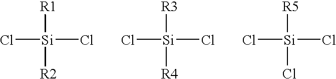
wherein R1, R2, R3, R4, and R5 represent an alkyl group, a cycloalkyl group, an aryl group, an aralkyl group, an alkaryl group, or an alkenyl group; provided that the R1 and R2 in the first dihalosilane are not the same as the R3 and R4 in the second dihalosilane.

6. The method according to claim 5 in which the alkali metal coupling agent is sodium.

7. The method according to claim 5 in which an alcohol having 1-8 carbon atoms is added to the reaction mixture to oxidize the alkali metal coupling agent.

8. A capped branched polysilane copolymer prepared by the method according to claim 5.
